(19) United States
(12) Patent Application Publication
(10) Pub. No.: US 2015/0006150 A1
(43) Pub. Date: Jan. 1, 2015

(54) USING A RULE ENGINE TO MANIPULATE SEMANTIC OBJECTS

(71) Applicant: International Business Machines Corporation, Armonk, NY (US)

(72) Inventors: Steven J. Demuth, Decorah, IA (US); Claus T. Jensen, Pawling, NY (US); Changhai N. Ke, Wissous (FR); Xu Li, Beijing (CN)

(21) Appl. No.: 13/932,039

(22) Filed: Jul. 1, 2013

(51) Int. Cl. G06F 17/27

(52) U.S. Cl. CPC G06F 17/2785
USPC 704/9

(57) ABSTRACT

Provided are techniques for the manipulation of semantic objects within a semantic store, including a semantic reasoning apparatus comprising a processor; a non-transitory computer-readable storage medium; a semantic store comprising a plurality of semantic objects; a semantic model; a rule, comprising a condition part and an action part; wherein the rule is based upon the semantic model and configured to execute the action part in response to a determination that the condition part is satisfied by one or more objects of the plurality of semantic objects and a semantic driver that employs the semantic model as input for driving behavior, comprising logic for determining that the condition part is satisfied by the one or more objects of the plurality of objects; and modifying a semantic object of the plurality of semantic objects in conformity to the action part in response to the determining that the condition part is satisfied.

### FIELD OF DISCLOSURE

The claimed subject matter relates generally to semantic modeling and, more specifically, to techniques for the manipulation of semantic objects within a semantic store.

### BACKGROUND OF THE INVENTION

Current state of the art allows semantic modeling of a business domain and the conversion of such a semantic model to a data model that represents information about the domain. Rule engines can leverage semantic models as the foundation for verbalization of domain specific rules and can do rule inference on domain data loaded in the rule engine, based upon a domain data model and type system mapping. In addition, specialized inference engines, or semantic reasoners, can infer semantic facts from existing semantic statement. These capabilities provide a semantic foundation for reasoning on information and data stored in databases and processed in information systems.

Beyond data stored in a database, semantic objects are themselves becoming increasingly important to business and information technology (IT) systems in that they capture operational business contexts and intentions in an actionable fashion. Historically, business entities and certain other aspects of operational business systems have only been captured in terms of the information and data they convey, thereby fitting the paradigm of rules and programs acting on data stored in databases.

### SUMMARY

As the inventors herein have realized, the conversion of domain objects to data stored in a database comes at the expense of a certain necessity of adaptation as well as a disassociation of business logic from the object to which it applies. For the purpose of operating, monitoring and managing operational business systems, business objects can and will change dynamically and independently of any action by a rule or inference engine. It should be noted that such changes can even include creation or deletion of semantic objects in their entirety. This exposes a gap in current rule engine capabilities; specifically, although current state of the art supports semantic reasoning on domain data, the state of the art does not enable rule engines to directly infer on and manipulate stored semantic objects in their current state in a persisted semantic store. In other words, current rule engines do not have the ability to dynamically interact with and directly manipulate objects in a semantic store, which implies not just mapping of the type system, but requires actually operating on the semantic store as the underlying “runtime” of the rule engine.

Provided are techniques for the manipulation of semantic objects within a semantic store, including a semantic reasoning apparatus, comprising a processor; a non-transitory computer-readable storage medium (CRSM) coupled to the processor; a semantic store comprising a plurality of semantic objects; a semantic model; a rule, comprising; a condition part; and an action part; wherein the rule is based upon the semantic model and configured to execute the action part in response to a determination that the condition part is satisfied by one or more objects of the plurality of semantic objects; and a semantic driver, stored on the CRSM and executed on the processor, that employs the semantic model as input for driving behavior, comprising logic for determining that the condition part is satisfied by the one or more objects of the plurality of objects; and modifying a semantic object of the plurality of semantic objects in conformity to the action part in response to the determining that the condition part is satisfied.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is a block diagram of a computing system architecture that may support the claimed subject matter.

FIG. 2 is a block diagram showing the relationships among various elements of a semantic system that may implement the claimed subject matter.

FIG. 3 is a block diagram of a semantic driver, first introduced in FIG. 1, that may implement aspects of the claimed subject matter.

FIG. 4 is a flowchart of an example of an “Author Semantic Object (SO) Rules” process that may implement aspects of the claimed subject matter.

FIG. 5 is a flowchart of an example of an “Evaluate Rules on Semantic Objects (SOs)” process that may implement aspects of the claimed subject matter.

FIG. 6 is a flowchart of an example of a “Derive New Data” process that may implement aspects of the claimed subject matter.

FIG. 7 is a flowchart of an example of a “Generate Constraint Rules” process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection, having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

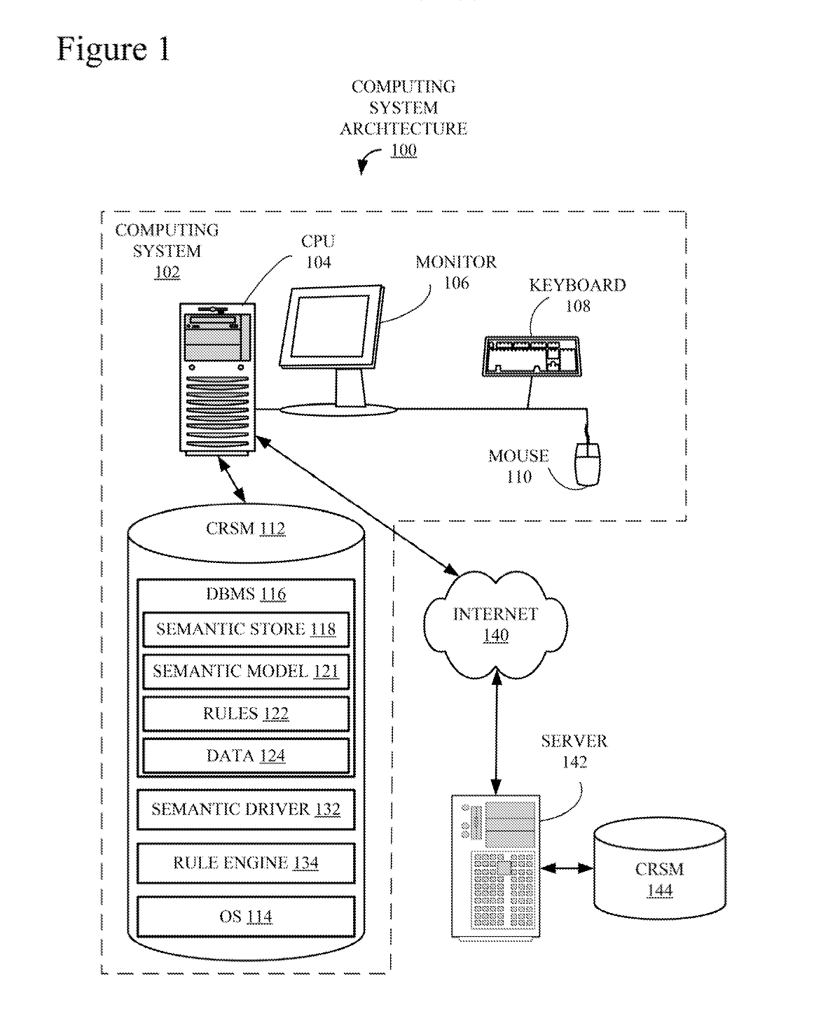

Turning now to the figures, FIG. 1 is a block diagram of one example of a computing system architecture 100 on which the claimed subject matter may be implemented. A computing system 102 includes a central processing unit (CPU) 104, coupled to a monitor 106, a keyboard 108 and a pointing device, or “mouse,” 110, which together facilitate human interaction with computing system 100 and computing system 102. Also included in computing system 102 and attached to CPU 104 is a computer readable storage medium (CRSM) 112, which may either be incorporated into computing system 102 i.e. an internal device, or attached externally to CPU 104 by means of various, commonly available connection devices such as but not limited to, a universal serial bus (USB) port (not shown).

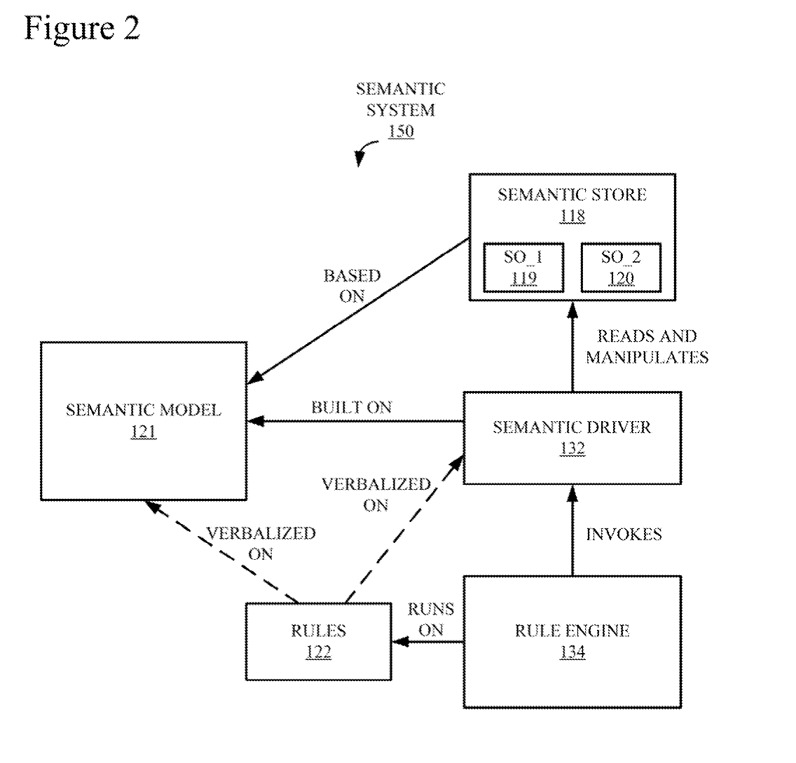

CRSM 112 is illustrated storing logic associated with an operating system (OS) 114 and an example of a database management system (DBMS) 116, which includes a semantic store 118, a semantic model 121, semantic rules, or simply “rules,” 122 and data 124. CRSM 112 also is illustrated storing logic associated with a semantic driver 132 and a semantic rule engine, or simply “rule engine,” 134. DBMS 116 and data 124 should be familiar to those with skill in the relevant arts. Semantic store 118, semantic model 121, rules 122, semantic driver 132 and rule engine 134 represent components of a semantic system that implements the claimed subject matter and are explained in more detail below in conjunction with FIGS. 2-7.

Computing system 102 and is connected to the Internet 140, which is also connected to a server computer 142. Like computing system 102, server would typically include a processor, CPU, monitor, keyboard and mouse, which are not illustrated for the sake of simplicity. Also coupled to server 142 is a CRSM 144. Further, although in this example, computing system 102 and server 142 are communicatively coupled via the Internet 140, they could also be coupled through any number of communication mediums such as, but not limited to, a local area network (LAN) (not shown). Further, it should be noted there are many possible computing system configurations, of which computing system architecture 100 is only one simple example.

FIG. 2 is a block diagram showing the relationships among various elements of a semantic system 150 that may implement the claimed subject matter. Semantic system 150 includes semantic store 118, semantic model 121, rules 122, semantic driver 132 and rule engine 134, all of which were introduced above in conjunction with FIG. 1. With respect to the terminology of the relationship between elements 118, 121, 122, 132 and 134 of system 150, semantic store 118 is based on semantic model 121; semantic driver 132 is built on semantic model 121; rule engine 134 runs on rules 122 and invokes semantic driver 132; and rules 122 are verbalized on semantic model 121 and semantic driver 132.

Semantic store 118 supports semantic reasoning and stores semantic objects, which in this example include two semantic objects, i.e., a SO_1 119 and a SO_2 120, which capture aspects of a business operating model, such as, but not limited to, business entities, properties of business entities and relationships between business entities. Semantic model 121 is a representation of domain knowledge and the “controller” for bow rule engine 134 interprets and interacts with semantic store 118.

Rules 122 express conditions and actions that are taken if the conditions are met. In the presence of semantic driver 132, rules 122 is based upon semantic model 121, which underlies semantic store 118 and is expressed in terms of classes, properties and instances of semantic model 121. Rule engine evaluates domain data to determine if rules conditions are met and takes defined actions if conditions are met. Semantic driver 132 enables rule engine 134 to dynamically interact with and directly manipulate objects such as SO_1 119 and SO_2 120 in semantic store 118 and allows rule conditions to be evaluated directly against objects in semantic store 118 and rule actions to change objects in semantic store 118. Both semantic driver 132 and rule engine 134 are domain agnostic in the described embodiment.

Each rule may be either a “constraint” or “non-constraint” rule. Non-constraint rules, or “general action rules,” are rules that are based on the current state of semantic store 118. In other words, if a condition associated with a non-constraint rule is TRUE based upon the current state of semantic store 118, then the corresponding action is executed. Both constraint and non-constraint rules may be employed in accordance with the claimed subject matter to maintain the underlying integrity of semantic store 118 and semantic model 121 (FIGS. 1 and 2), i.e. modify objects in semantic store 118 based upon conditions defined in semantic model 121. In addition, a constraint rule may be automatically generated based upon information in semantic model 121, i.e. not generated by an administrator. For example, semantic model 121 may specify that there is a one-to-one relationship between SO_1 119 (FIG. 2) and SO_2 120 (FIG. 2). This constraint may be used to generate a rule that automatically enforces the constrain on semantic store 121 by modifying SO_1 119, SO_2 120 or both. In short, constraint rules may modify semantic store 121 to “fix” a non-compliance with an asserted constraint, whereas a typical semantic reasoning system would simply report an inconsistency.

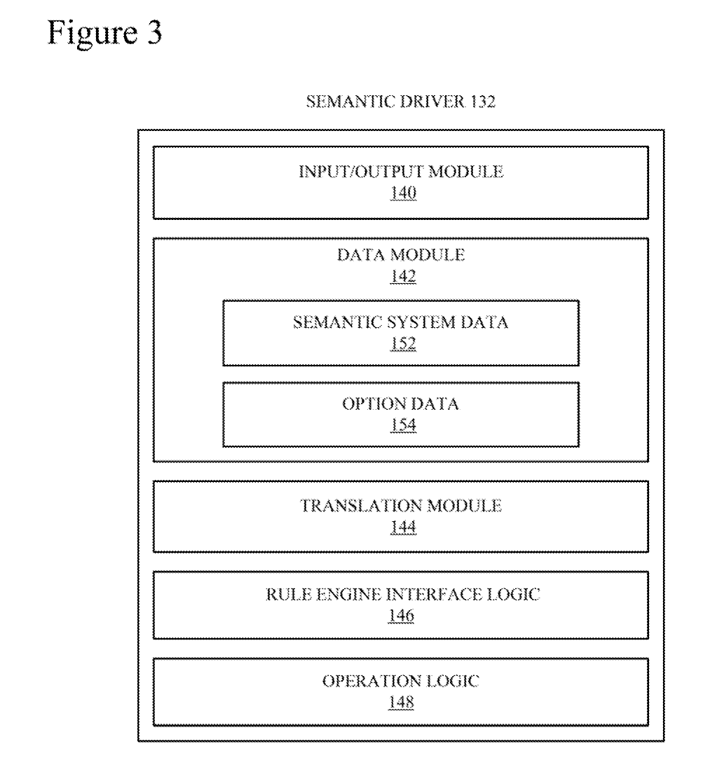

FIG. 3 is a block diagram of semantic driver 132, described in FIGS. 1 and 2, which implements aspects of the claimed subject matter. In this example, semantic driver 132 is associated with logic stored on CRSM 112 (FIG. 1) and executed on one or more processors (not shown) of CPU 104 (FIG. 1) and computing system 102 (FIG. 1).

Semantic driver 132 includes an input/output (I/O) module 140, a data module 142, a translation module 144, a rule engine interface module 146 and operation logic 148. It should be understood that the claimed subject matter can be implemented in many types of computing systems and data storage structures but, for the sake of simplicity, is described only in terms of computer 102 and system architecture 100 (FIG. 1). Further, the representation of semantic driver 132 in FIG. 3 is a logical model. In other words, components 140, 142, 144, 146 and 148 may be stored in the same or separates files and loaded and/or executed within computing system 102 and architecture 100 either as a single system or as separate processes interacting via any available inter process communication (IPC) techniques.

I/O module 149 handles any communication semantic driver 132 has with other components of system 100. Data module 142 is a data repository for information, including settings and information, that semantic driver 132 requires during normal operation. Examples of the types of information stored in data module 142 include semantic system data 152, which enable semantic driver 132 to identify and connect with other components of semantic system 150 (FIG. 2) such as semantic store 118 (FIG. 2), semantic model 121, rules 122 and rule engine 134. Option data 154 includes information on various user preferences that have been set. For example, a user may define various parameters that control the operation of semantic driver 132 such as, but not limited to, “optimistic” or “pessimistic” modes for locks on semantic data updates.

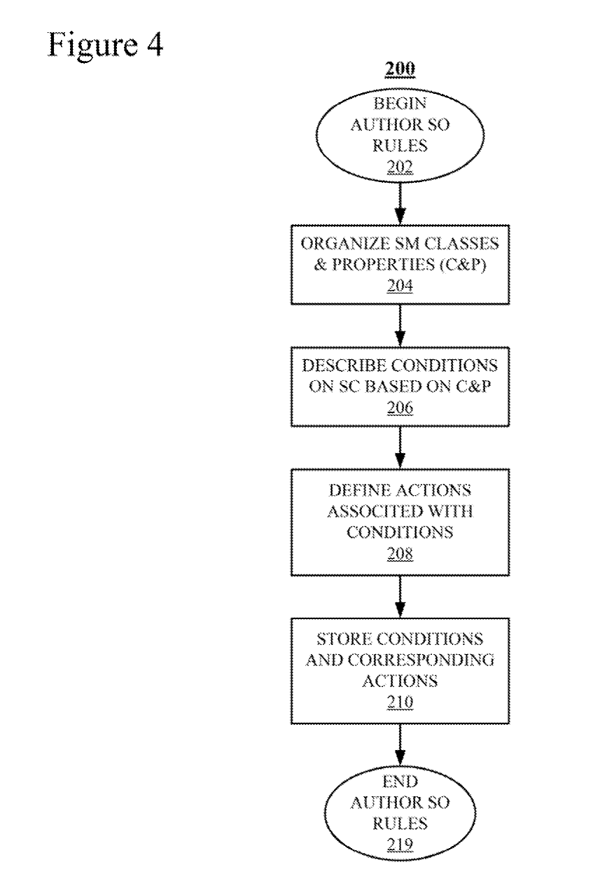

Translation nodule 144 translates from the rules 122 (FIGS. 1 and 2) of rule engine 134 (FIGS. 1 and 2), which is responsible of the evaluation of rule expression and derivation of conditions and actions that may result in data updates, to operations on semantic store 118 (FIGS. 1 and 2). Such derived conditions and actions are processed through rule engine interface 146. In this manner, rule engine interface module 146 enables rule engine 134 to run “live” on semantic store 118, mitigating the need to load snapshot data from semantic store 118 directly into rule engine 134. One particular benefit of this approach is that semantic driver 132 can be engineered generally such that its behavior may be based upon definitions in semantic model 121 (FIGS. 1 and 2). Operation logic 148 includes logic for coordinating the operation of modules 140, 142, 144 and 146. Components 142, 144, 146, 148, 150, 152 and 154 are described in more detail below in conjunction with FIGS. 4-7.

FIG. 4 is a flowchart of an example of an “Author Semantic Object (SO) Rules” process 200 that may implement aspects of the claimed subject matter. Typically, actions associated with process 209 would be executed by system architect, analyst or administrator with results stored, in this example, in CRSM 112 (FIG. 1) and executed on one or more processors (not shown) of CPU 104 (FIG. 1) of computing, system 102 (FIG. 1).

Process 200 starts in a “Begin Author Semantic Object (SO) Rules” block 292 and proceeds immediately to an “Organize Semantic Model (SM) classes and properties (C&P)” block 204. During processing associated with block 204, a subset of classes and properties associated with semantic model 121 (FIGS. 1 and 2) are selected for timber processing. During processing associated with a “Describe Conditions on Semantic Content (SC) Based on C&P)” block 206, condition portions of rules 122 (FIGS. 1 and 2) are defined with respect to the classes and properties selected during processing, associated with 204. During processing associated with a “Define Actions Associated With Conditions” block 208, each set of conditions described during processing associated with block 206 is associated with one or more actions, which may include updates to semantic data 124 (FIG. 1), and are defined, using a verbalization language defined as part of semantic driver 132 (FIGS. 1-3). In this manner, the typical vocabulary of the action portion of rules 122 provided as part of a standard rule engine is extended.

During processing associated with a “Save Conditions and Corresponding Actions” block 210, the conditions described during processing associated with block 206 and the corresponding actions defined during processing associated with block 208 are saved, in this example, to CRSM 112 as part of the environment of rule engine 134 (FIGS. 1 and 2). Finally, process 200 proceeds to an “End Author SO Rules” block 219 in which process 200 is complete.

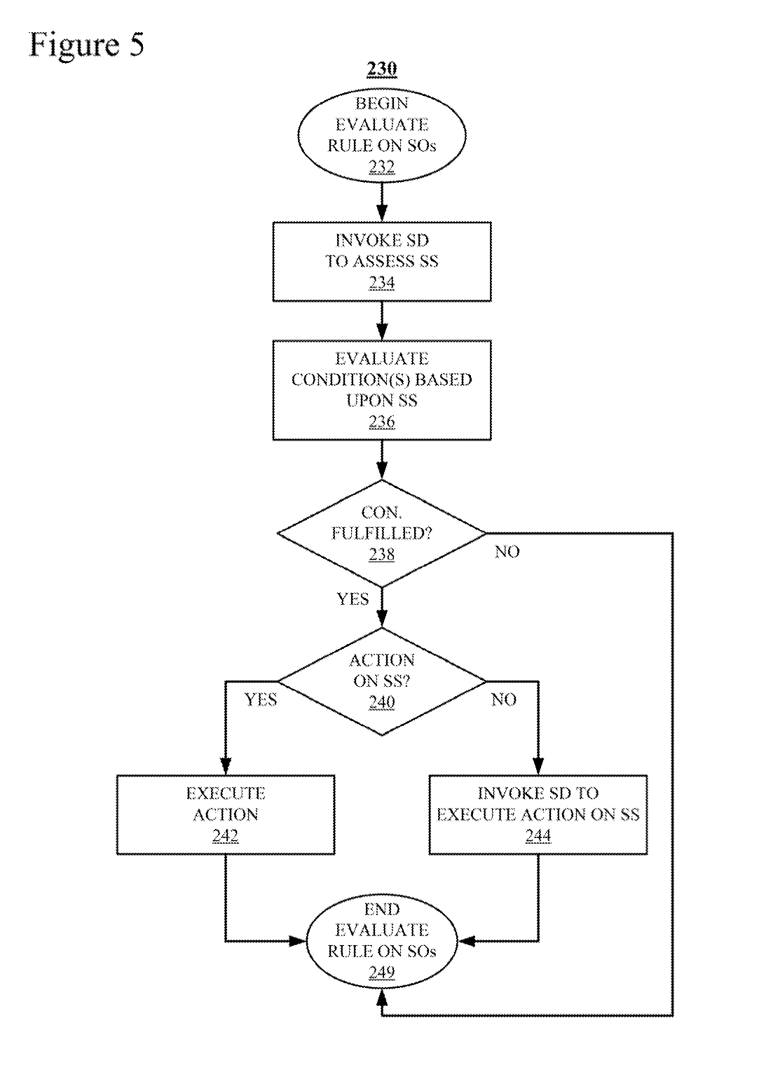

FIG. 5 is a flowchart of an example of an “Evaluate Rule on Semantic Objects (SOs)” process 230 that may implement aspects of the claimed subject matter. In this example, process 230 is associated with logic stored on CRSM 112 (FIG. 1) in conjunction with semantic driver 132 (FIGS. 1-3) and executed on one or more processors (not shown) of CPU 104 (FIG. 1) of computing system 102 (FIG. 1). It should be understood that, although explained in conjunction with the evaluation of one rule in accordance with the claimed subject matter, i.e., the “current” rule, process 230 may typically be applied to many if not all rules in rules 122 (FIGS. 1 and 2) in an iterative or batch fashion.

Process 230 starts in a “Begin Evaluate Rule on Semantic Objects (SOs)” block 232 and proceeds immediately to an “Invoke Semantic Driver (SD) to Access Semantic Store (SS)” block 234. During processing associated with block 234, process 230 invokes semantic driver 132 to evaluate semantic store 118 (FIGS. 1 and 2) with respect to the current rule. During processing associated with an “Evaluate Condition(s) Based Upon SS” block 236, the condition part of the current rule is evaluated with respect to the data in semantic store 118. During processing associated with a “Condition (Con.) Fulfilled?” block 238, a determination is made as to whether or not the facts in semantic store 118 indicate that the condition of the current rule is satisfied. If so, control proceeds to an “Action on Semantic Store (SS)?” block 240.

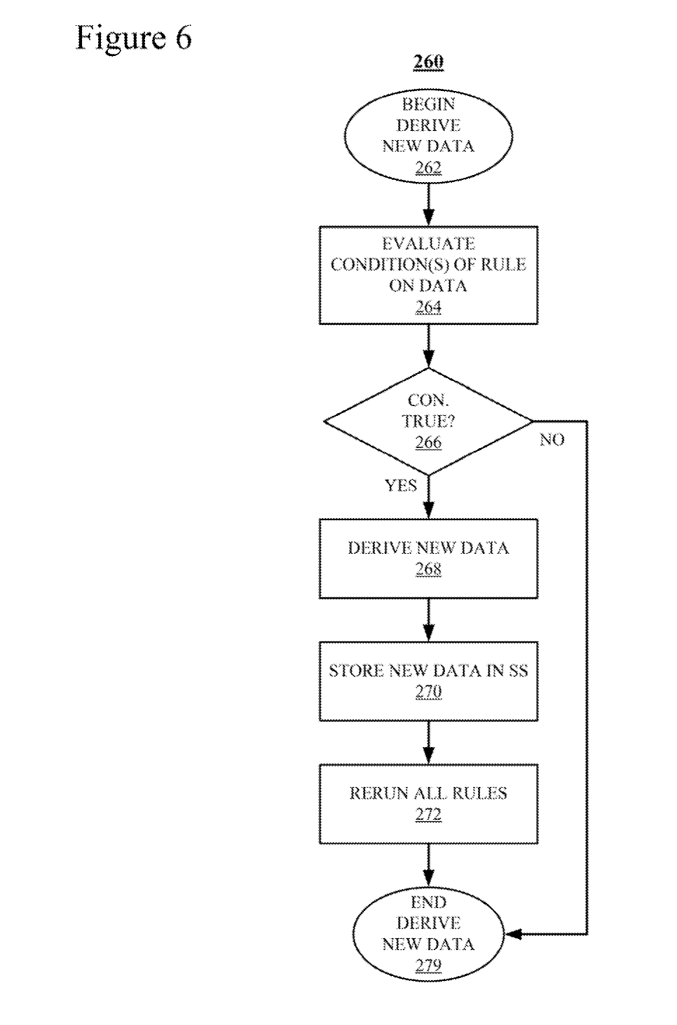

During processing associated with block 240, a determination is made as to whether or not the action associated with the current rule acts on, or modifies, an object of semantic store 118. If a determination is made that the current rule does not act on objects in SS 118, control proceeds to an “Execute Action” block 242. During processing associated with block 242, the action associated with the current rule is executed. If during processing associated with block 240, a determination is made that the current rule does act on one or more objects of SS 118, then control proceeds to an “Invoke Semantic Driver (SD) to Execute Action on Semantic Store (SS)” block 244. During processing associated with block 244, semantic driver 132 may change semantic objects, such as SO_1 119 and SO_2 120, to ensure consistency between semantic store 118 and semantic model 121. Processing associated with block 244 is described in more detail below in conjunction with FIG. 6. Finally, control proceeds to an “End Evaluate Rule SOs” block 249 in which process 230 is complete.

FIG. 6 is a flowchart of an example of a “Derive New Data” process 260 that may implement aspects of the claimed subject matter. Like process 230, in this example, process 260 is associated with logic stored on CRSM 112 (FIG. 1) in conjunction with semantic driver 132 (FIGS. 1-3) and executed on one or more processors (not shown) of CPU 104 (FIG. 1) of computing system 102 (FIG. 1). In addition, in this example, process 260 is associated with block 244 (FIG. 5) of process 230 (FIG. 5) in that certain actions in accordance with the claimed subject matter may alter data stored in semantic store 118 (FIGS. 1 and 2).

Process 260 starts in a “Begin Derive New Data” block 262 and proceeds immediately to an “Evaluate Condition(s) of Rule on Data” block 234. During processing associated with block 264, the conditional portion of the current rule (see FIG. 5) is evaluated. It should be noted that the data necessary to evaluate a condition may be retrieved from sources other than merely semantic store 118. For example, one condition associated with a rule may rely upon the current time and date in Tokyo, Japan with a definition of “current time” defined as part of semantic model 121 (FIGS. 1 and 2). Another example of a condition may be whether or not it is nighttime in Tokyo, which would depend upon both the current time in Tokyo and a definition that “nighttime” is between 10 PM and 7 AM. In these examples, the definition of how to determine current time and nighttime is defined as part of semantic model 121 but actual information needed to evaluate the condition must be retrieved from an external source, defined within the model based upon the vocabulary.

Another example would be a condition that relies upon whether or not a particular student is “full time.” If a full time student is defined in semantic model 121 as a degree seeking student, enrolled in three (3) or more classes that are not audits and are for a total of more than eleven (11) credit hours, then the definition would be defined using the vocabulary of semantic model 121 but information about the student necessary to arrive at a conclusion may be stored externally, for example in a student database.

During processing associated with a “Condition (Con.) True?” block 266 a determination is made as to whether or not the condition evaluated during processing associated with block 264 is TRUE. If so, control proceeds to a “Derive New Data” block 268. During processing associated with block 268, the action portion of the rule is executed and new data is derived. As explained above, a rule may necessitate modification of objects such as SO_1 119 (FIG. 2) and SO_2 120 (FIG. 2) of semantic store 118.

During processing associated with a “Store New Data in Semantic Store (SS)” block 270, the new data derived during processing associated with block 268 is stored in semantic store 118. During processing associated with a “Rerun All Rules” block 272, the rules in rule 122 (FIGS. 1 and 2), including the current rule, are rerun because the objects of semantic store 118 have been changed during processing associated with block 268 and 270. In this manner, SS 118 may be “auto adjusted” until a particular constraint is satisfied. Finally, during processing associated with an “End Derive New Data” block 279, process 260 is complete.

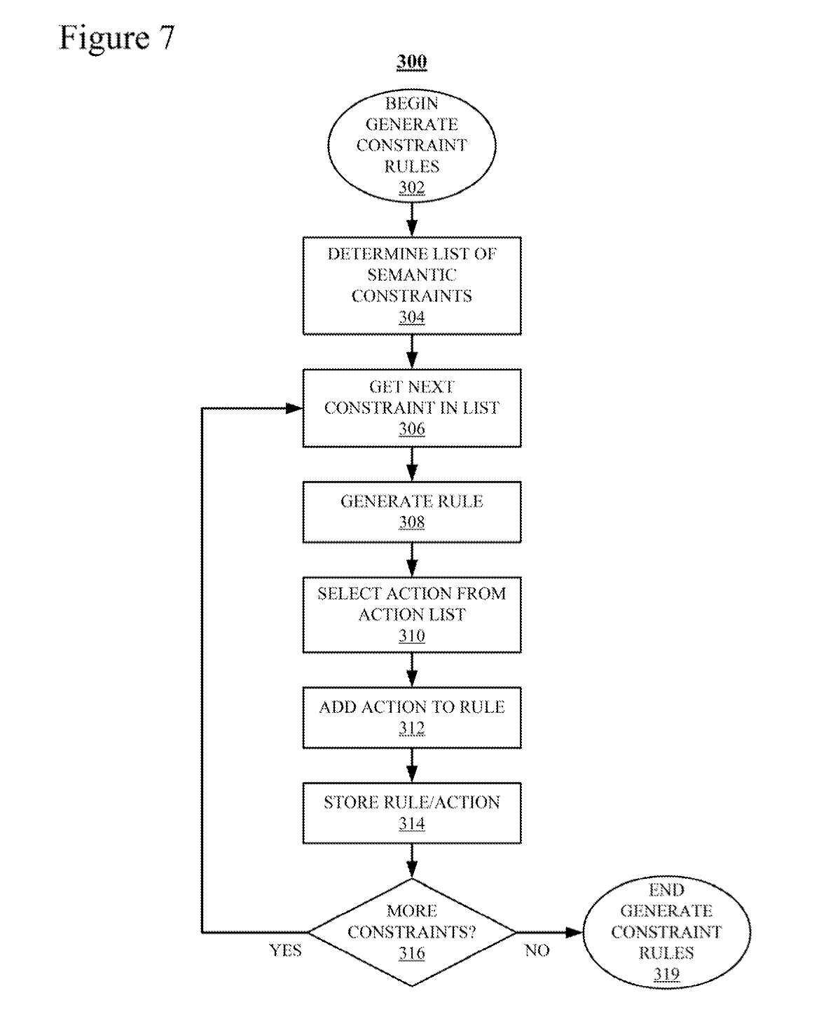

FIG. 7 is a flowchart of an example of a “Generate Constraint Rules” process 300 that may implement aspects of the claimed subject matter. Like process 200 (FIG. 4), some actions associated with process 300 may be executed by system architect, analyst or administrator with results stored, in this example, in CRSM 112 (FIG. 1) and executed on one or more processors (not shown) of CPU 104 (FIG. 1) of computing system 102 (FIG. 1).

Process 300 starts in a “Begin Generate Constraint Rules” block 302 and proceeds immediately to an “Determine List of Semantic Constraints” block 304. During processing associated with block 304, a list of constraints, defined as part of semantic model 121 (FIGS. 1 and 2), is generated. Such a list may be generated by a user such as a system architect or administrator or auto-generated programmatically. Some examples of such constraints include, but are not limited to, the cardinality of a relationship among objects in semantic store 118, the type of the relationship, the type of an attribute associated with an object and so on. During processing associated with a “Get Next Constraint in List” block 306, processing of the list generated during processing associated with block 304 is initiated by selecting an unprocessed constraint from the list of constraints.

During processing associated with a “Generate Rule” block 308, the constraint selected during processing associated with block 306 is associated with a rule. For example, for an instance of attribute type that specifies that the type of attribute X must be type Y, the rule may be “if type of attribute X is not Y.” Typically, a constraint rule is TRUE if a corresponding semantic constraint is not fulfilled, i.e., the rule “fires” when the constraint is broken. During, processing associated with “Select Action From Action List” block 310, and an action for the rule defined during processing associated with block 308. In this example, a list of possible action is provided. For example, possible actions may include “remove inappropriately typed attribute,” “change the remove inappropriately typed attribute” or “flag the inconsistency so that the issue may be resolved by an external system intervention.”

During processing associated with an “Add Action to Rule” block 312, the action selected during processing associated with block 310 is paired with the rule generated during processing associated with block 308. In other words, the generated rule is paired with the selected action. During processing, associated with a “Store Rule/Action” block 314, the rule action pair generated during processing, associated with block 312is stored in rules 122 (FIGS. 1 and 2).

During processing associated with a “More Constraints?” block 316, a determination is made as to whether or not there are unprocessed rules in the list generated during processing associated with block 304. If so, control returns to block 306, the next unprocessed rule is selected and processing continues as described above. In not, control proceeds to an “End Generate Constraint Rules” block 319 during which process 300 is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing, the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block, in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending, upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. An semantic reasoning apparatus, comprising:
a processor;
a non-transitory computer-readable storage medium (CRSM) coupled to the processor;
a semantic store comprising a plurality of semantic objects;
a semantic model;
a rule, comprising;
a condition part; and
an action part;
wherein the rule is based upon the semantic model and configured to execute the action part in response to a determination that the condition part is satisfied by one or more objects of the plurality of semantic objects; and
a semantic driver, stored on the CRSM and executed on the processor, that employs the semantic model as input for driving behavior, comprising logic, for:
determining that the condition part is satisfied by the one or more objects of the plurality of objects; and
modifying a semantic object of the plurality of semantic objects in conformity to the action part in response to the determining that the condition part is satisfied.

2. The apparatus of claim 1, the logic further comprising logic for inferring the rule based upon information stored in conjunction with the semantic model.

3. The apparatus of claim 1, the logic further comprising logic for inferring new information for inclusion in the semantic store.

4. The apparatus of claim 1, wherein data employed to evaluate the condition part of the rule is retrieved from a source external to the semantic store.

5. The apparatus of claim 1, the logic further comprising logic for re-evaluating a second rule in response to modifying of the semantic object.

6. The apparatus of claim 1, where in the semantic model is expressed in a semantic language from a list, the list consisting of:
web ontology language (OWL);
semantic web rule language (SWRL);
defense advanced research projects agency agent markup language (DAML);
ontology inference layer (OIL); and
DAML+OIL.

7. The apparatus of claim 1, the semantic driver further comprising logic for extending a language associated with the rule.

8. A sematic driver, comprising:
a processor;
a non-transitory computer-readable storage medium (CRSM) coupled to the processor;
a semantic driver, stored on the CRSM and executed on the processor, that employs a semantic model as input for driving behavior, comprising logic for:
determining that a condition part of a rule, based upon the semantic model and configured to execute an action part of the rule in response to a determination that the condition part, is satisfied by one or more objects of a plurality of semantic objects of a semantic store, is satisfied; and
modifying a semantic object of the plurality of semantic objects in conformity with the action part response to the determining the condition part of the rule is satisfied.

9. The semantic driver of claim 8, the logic further comprising logic for inferring the rule based upon information stored in conjunction with the semantic model.

10. The semantic driver of claim 8, the logic further comprising logic for inferring new information for inclusion in the semantic store.

11. The semantic driver of claim 8, wherein data employed to evaluate the condition part of the rule is retrieved from a source external to the semantic store.

12. The semantic driver of claim 8, the logic further comprising logic for re-evaluating a second rule in response to modifying of the semantic object.

13. The semantic driver of claim 8, where in the semantic driver is expressed in a semantic language from a list, the list consisting of:
web ontology language (OWL);
semantic web rule language (SWRL);
defense advanced research projects agency agent markup language (DAML);
ontology inference layer (OIL); and
DAML+OIL.

14-19. (canceled)

20. A computer programming product, comprising:
a non-transitory, computer-readable storage medium; and
logic, stored on the non-transitory, computer-readable storage medium for execution on a processor, for:
evaluating, by a semantic driver that employs a semantic model as input for driving behavior, a rule, the rule comprising;
a condition part; and
an action part;
wherein the rule is based upon the semantic model and configured to execute the action part in response to a determination that the condition part is satisfied by one or more objects of a plurality of semantic objects of a semantic store; and
determining that the condition part is satisfied based upon the evaluating; and, in response to the determining,
modifying a semantic object of the plurality of semantic objects in conformity to the action part.

21. The computer programming product of claim 20, the logic further comprising logic for inferring the rule based upon information stored in conjunction with the semantic model.

22. The computer programming product of claim 20, the logic further comprising logic for inferring new information for inclusion in the semantic store.

23. The computer programming product of claim 20, wherein data employed to evaluate the condition part of the rule is retrieved from a source external to the semantic store.

24. The computer programming product of claim 20, the logic further comprising logic for re-evaluating a second rule in response to modifying of the semantic object.

25. The computer programming product of claim 20, where in the semantic model is expressed in a semantic language from a list, the list consisting of:
web ontology language (OWL);
semantic web rule language (SWRL);
defense advanced research projects agency agent markup language (DAML);
ontology inference layer (OIL); and
DAML+OIL.
